(19) United States
(12) Patent Application Publication
(10) Pub. No.: US 2026/0049521 A1
(43) Pub. Date: Feb. 19, 2026

(54) WEEPING SYSTEMS FOR FENESTRATION UNITS

(71) Applicant: Frank Joseph Tortorella, JR., Park Ridge, IL (US)

(72) Inventor: Frank Joseph Tortorella, JR., Park Ridge, IL (US)

(21) Appl. No.: 19/295,371

(22) Filed: Aug. 8, 2025

Related U.S. Application Data
(60) Provisional application No. 63/683,206, filed on Aug. 14, 2024.
(60) Provisional application No. 63/804,381, filed on May 12, 2025.

(51) Int. Cl. E06B 7/14

(52) U.S. Cl. CPC E06B 7/14

(57) ABSTRACT

Weeping systems for fenestration units are disclosed. In an implementation, an apparatus includes a fenestration unit, including a frame, including a head, a first jamb, a second jamb, and a sill. The first jamb and the second jamb coupled to and between the head and the sill. The head, the first jamb, the second jamb, and the sill include a perimeter drainage channel. Each of the head and the sill include weep holes fluidly coupled to the perimeter drainage channel.

### RELATED APPLICATION SECTION

This application claims the benefit of and priority to U.S. Provisional Patent Application No. 63/683,206, filed Aug. 14, 2024, and U.S. Provisional Patent Application No. 63/804,381, filed May 12, 2025, the content of each of which is incorporated by reference herein in their entireties and for all purposes.

### FIELD OF THE DISCLOSURE

The present disclosure relates to fenestration units and, more particularly, to weeping systems for fenestration units.

### BACKGROUND

Buildings often have openings in which a fenestration unit such as a window or door is installed.

### SUMMARY

In a first implementation, an apparatus includes a fenestration unit including a frame, including a head, a first jamb, a second jamb, and a sill. The first jamb and the second jamb are coupled to and between the head and the sill. The head, the first jamb, the second jamb, and the sill include a perimeter drainage channel. Each of the head and the sill include weep holes fluidly coupled to the perimeter drainage channel.

In a second implementation, an apparatus includes a frame including a head, a first jamb, a second jamb, and a sill. The first jamb and the second jamb are coupled to and between the head and the sill. The head includes a first head partition wall, a head exterior wall, and a second head partition wall. The first head partition wall includes a first weep hole of the weep holes. The first head partition wall defines a drainage channel. A head exterior wall includes an exterior head face and a second weep hole of the weep holes. A second head partition wall extends between the first head partition wall and the head exterior wall. The second head partition wall includes a fluid exit path between the first weep hole and the second weep hole.

Fluid communication between the drainage channel, the first weep hole, and the second weep hole enables fluid to flow from the drainage channel, through the first weep hole, and out of the second weep hole of the head exterior wall.

In a third implementation, an apparatus includes a frame includes a head, a first jamb, a second jamb, and a sill. The first jamb and the second jamb are coupled to and between the head and the sill. The head includes an interior head top wall, a first head partition wall, a head exterior wall, a second head partition wall, a head exterior wall, an exterior head top wall, and a head mounting flange. An interior head top wall includes an aperture. The interior head top wall defines a drainage channel along the head. The aperture is fluidly coupled to the drainage channel. The first head partition wall includes a first weep hole of the weep holes. The first head partition wall defines the drainage channel. The head exterior wall includes an exterior head face and a second weep hole of the weep holes. The second head partition wall extending between the first head partition wall and the head exterior wall. The second head partition wall includes a fluid exit path between the first weep hole and the second weep hole, an exterior head top wall; and a head mounting flange that separates the interior head top wall and the exterior head top wall. Fluid communication between aperture of the head top wall, the drainage channel, the first weep hole, and the second weep hole enables fluid to flow through the aperture, into the drainage channel, through the first weep hole, and out of the second weep hole of the head exterior wall.

In a fourth implementation, an apparatus includes a fenestration unit including a frame including a head, a first jamb, a second jamb, and a sill. The first jamb and the second jamb are coupled to and between the head and the sill. The head includes a drainage channel, and weep holes fluidly coupled to the drainage channel to evacuate fluid to an exterior at the head.

In further accordance with the foregoing first, second, third, and/or fourth implementations, an apparatus and/or method may further comprise or include any one or more of the following:

In an implementation, the head includes a first head partition wall that includes a first weep hole of the weep holes. The first head partition wall defines the perimeter drainage channel. A head exterior wall includes an exterior head face and a second weep hole of the weep holes. A second head partition wall extends between the first head partition wall and the head exterior wall. The second head partition wall includes a fluid exit path between the first weep hole and the second weep hole.

In another implementation, the head includes an interior head top wall including an aperture, an exterior head top wall, and a head mounting flange. The aperture is fluidly coupled to the perimeter drainage channel. The interior head top wall defines the perimeter drainage channel along a width of the head. The head mounting flange separates the interior head top wall and the exterior head top wall.

In another implementation, fluid communication between the aperture of the interior head top wall, the perimeter drainage channel, the first weep hole, and the second weep hole enables fluid to flow from the interior head top wall, through the aperture, into the perimeter drainage channel, through the first weep hole, and out of the second weep hole of the head exterior wall.

In another implementation, the head includes a third head partition wall extending from the first head partition wall. The third head partition wall defines the perimeter drainage channel and is positioned beneath the interior head top wall.

In another implementation, each of the first jamb and the second jamb include an interior jamb side wall, an exterior jamb side wall, a jamb mounting flange that separates the interior jamb side wall and the exterior jamb side wall, and a jamb partition wall. The exterior jamb side wall and the jamb partition wall define the perimeter drainage channel.

In another implementation, the jamb partition wall and the third head partition wall are coupled.

In another implementation, the interior jamb side wall and the interior head top wall are coupled.

In another implementation, the sill includes an interior sill bottom wall, an exterior sill bottom wall, a sill mounting flange that separates the interior sill bottom wall and the exterior sill bottom wall, and a first sill partition wall. The interior sill bottom wall and the first sill partition wall define the perimeter drainage channel.

In another implementation, the first sill partition wall includes a third weep hole of the weep holes. The sill includes a sill drainage channel spaced above the perimeter drainage channel, the third weep hole fluidly coupling the sill drainage channel and the perimeter drainage channel.

In another implementation, the sill includes a second sill partition wall that extends between the interior sill bottom wall and the first sill partition wall. The second sill partition wall defines the perimeter drainage channel and includes a fourth weep hole of the weep holes. A sill exterior wall includes an exterior sill face and a fifth weep hole of the weep holes. A third sill partition wall extends between the second sill partition wall and the sill exterior wall. The third sill partition wall includes a second fluid exit path between the fourth weep hole and the fifth weep hole.

In another implementation, fluid communication between the sill drainage channel, the third weep hole, the perimeter drainage channel, the fourth weep hole, and the fifth weep hole enables fluid to flow from the sill drainage channel, through the third weep hole, into the perimeter drainage channel, through the fourth weep hole, and out of the fifth weep hole of the sill exterior wall.

In another implementation, the jamb partition wall and the first sill partition wall are coupled.

In another implementation, the interior jamb side wall and the interior sill bottom wall are coupled.

In another implementation, further including wicking material.

In another implementation, the wicking material is positioned in or adjacent the perimeter drainage channel, the fluid exit path, or the second fluid exit path.

In another implementation, the fenestration unit includes a window.

In another implementation, the fenestration unit includes a door.

In another implementation, the head includes an interior head top wall includes an aperture, an exterior head top wall, and a head mounting flange. The interior head top wall defines the drainage channel along a width of the head. The aperture fluidly coupled to the drainage channel. The head mounting flange separates the interior head top wall and the exterior head top wall.

In another implementation, the head includes a third head partition wall extending from the first head partition wall, the third head partition wall defines the drainage channel and is positioned beneath the interior head top wall.

In another implementation, the frame includes a perimeter drainage channel includes the drainage channel. The sill includes an interior sill bottom wall. A first sill partition wall includes a third weep hole. The interior sill bottom wall and the first sill partition wall define the perimeter drainage channel. A sill drainage channel is spaced above the perimeter drainage channel. The third weep hole fluidly couples the sill drainage channel and the perimeter drainage channel.

In another implementation, the head includes a third head partition wall extending from the first head partition wall. The third head partition wall defines the drainage channel and is positioned beneath the interior head top wall.

In another implementation, the head includes a first head partition wall including a first weep hole of the weep holes. The first head partition wall defines the drainage channel. A head exterior wall including an exterior head face and a second weep hole of the weep holes. A second head partition wall extending between the first head partition wall and the head exterior wall. The second head partition wall includes a fluid exit path between the first weep hole and the second weep hole.

In another implementation, the head includes an interior head top wall including an aperture. The aperture is fluidly coupled to the drainage channel. The interior head top wall defines the drainage channel. An exterior head top wall; and a head mounting flange that separates the interior head top wall and the exterior head top wall.

In another implementation, fluid communication between the aperture of the interior head top wall, the drainage channel, the first weep hole, and the second weep hole enables fluid to flow from the interior head top wall, through the aperture, into the drainage channel, through the first weep hole, and out of the second weep hole of the head exterior wall.

In another implementation, the head includes a third head partition wall extending from the first head partition wall, the third head partition wall defines the drainage channel and is positioned beneath the interior head top wall.

In another implementation, the drainage channel includes ends.

In another implementation, the ends encourage the fluid to flow from the drainage channel and out of the weep holes of the head.

In another implementation, the ends discourage the fluid from flowing from the drainage channel and through or along the first jamb or the second jamb.

In another implementation, the fenestration unit includes a door.

In another implementation, the fenestration unit includes a window.

### BRIEF DESCRIPTION OF THE DRAWINGS

FIG. 1 is a schematic illustration of a fenestration unit in accordance with the teachings of this disclosure.

FIG. 2 is a front view of a window that can be used to implement the fenestration unit of FIG. 1.

FIG. 3 is a detailed isometric cross-sectional view of the head of the window of FIG. 2.

FIG. 4 is another detailed isometric cross-sectional view of the head of the window of FIG. 2.

FIG. 5 is a detailed isometric partial cross-sectional view of the head and the second jamb of the window of FIG. 2.

FIG. 6 is a detailed isometric partial cross-sectional view of the second jamb and the sill of the window of FIG. 2.

FIG. 7 is a cross-sectional view of the window of FIG. 2 taken along lines 7-7 of FIG. 2.

FIG. 8 is a cross-sectional view of the window of FIG. 2 taken along lines 8-8 of FIG. 2.

FIG. 9 is a cross-sectional view of the window of FIG. 2 taken along lines 9-9 of FIG. 2.

FIG. 10 is a schematic illustration of a fenestration unit 300 in accordance with the teachings of this disclosure.

### DETAILED DESCRIPTION

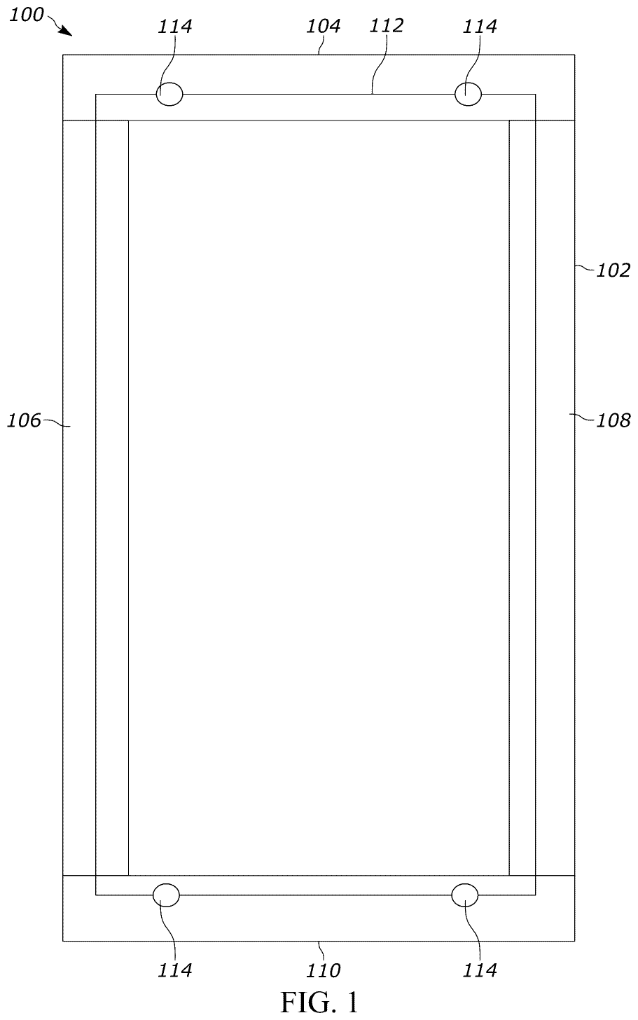

FIG. 1 is a schematic illustration of a fenestration unit 100 in accordance with the teachings of this disclosure. The fenestration unit 100 may be implemented by a window and/or a door as examples. The fenestration unit 100 includes a frame 102. The frame includes a head 104, a first jamb 106, a second jamb 108, and a sill 110. The first jamb 106 and the second jamb 108 are coupled to and between the head 104 and the sill 110.

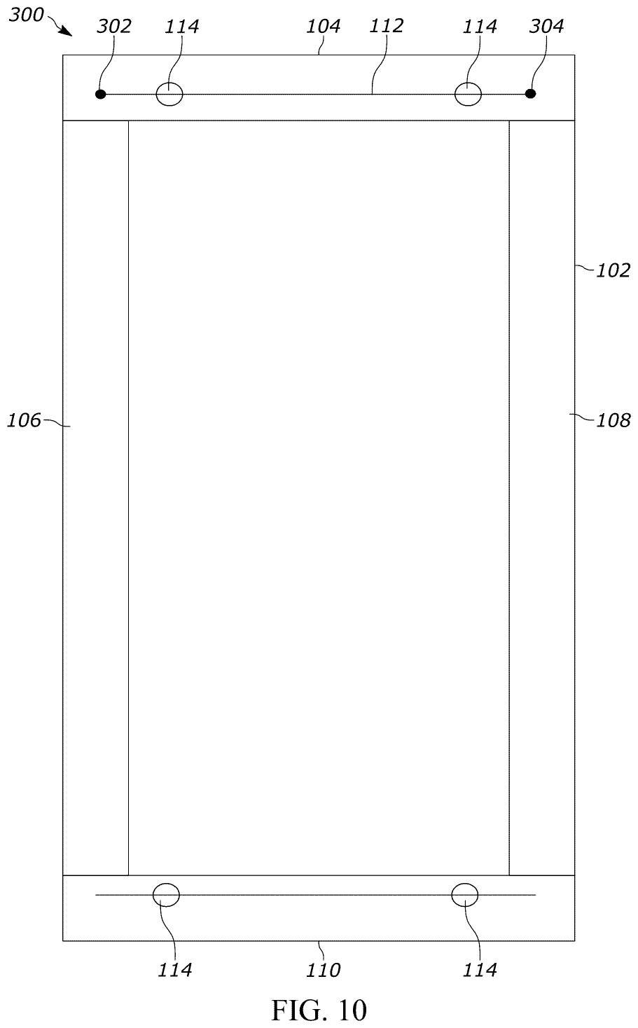

The head 104, the first jamb 106, the second jamb 108, and/or the sill 110 include a drainage channel 112 in the implementation shown. The head 104 may include the drainage channel 112 in some implementations and one or more of the first jamb 106, the second jamb 108, and/or the sill 110 may not include the drainage channel 112. The head 104 and the sill 110 may include separate drainage channels 112 in other implementations (see, FIG. 10).

The drainage channel 112 is shown as a perimeter drainage channel. Portions of the drainage channel 112 may alternatively be omitted. For example, the first jamb 106 and/or the second jamb 108 may not include the drainage channel as an example. The head 104 and the sill 110 each have weep holes 114 fluidly coupled to the drainage channel 112 in the implementation shown.

Fluid may flow into the drainage channel 112 on an interior of the structure in which the fenestration unit 100 is installed and the fluid may flow out of the weep holes 114 on the exterior of the structure. The structure may be a residential building, a commercial building, a single-family home, an apartment complex, a garage, etc. The drainage channel 112 may be a built-in pathways within the frame 102 that guide water towards the weep holes 114, for example. All or portions of the drainage channel 112 may be sloped to facilitate drainage, for example.

The fenestration unit 100 may have any number of weep holes 114 at the head 104, any number of weep holes 114 at the sill 110, and/or any number of weep holes 114 at the first jamb 106 and/or the second jamb 108. The first jamb 106 and/or the second jamb 108 may include zero weep holes as an example. The head 104 may have more weep holes 114 than the sill 110. The head 104 may alternatively have less weep holes 114 than the sill 110.

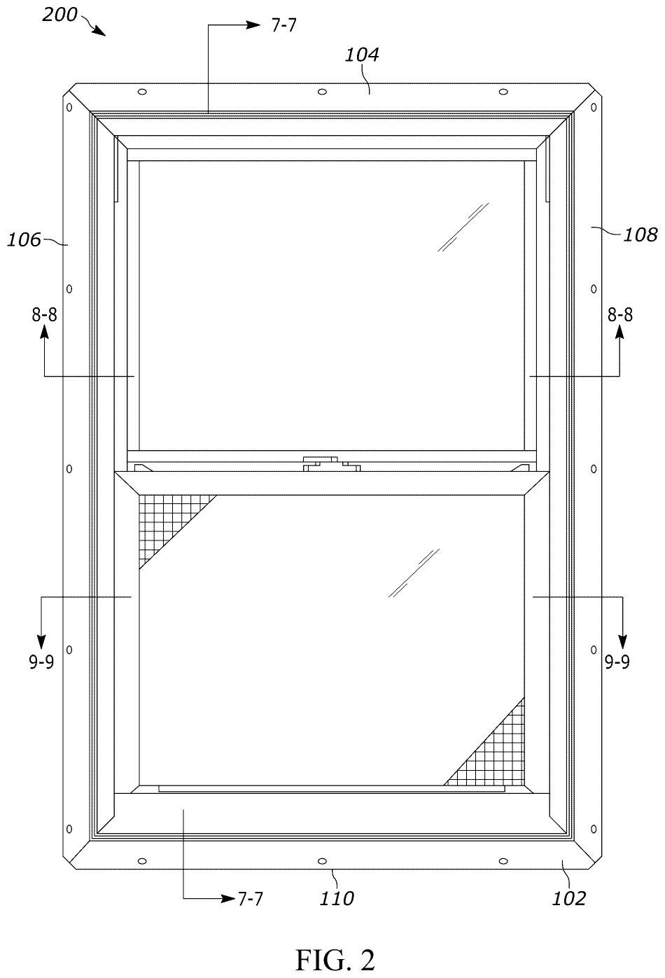

FIG. 2 is a front view of a window 200 that can be used to implement the fenestration unit 100 of FIG. 1. The window 200 includes the frame 102 that includes the head 104, the first jamb 106, the second jamb 108, and the sill 110.

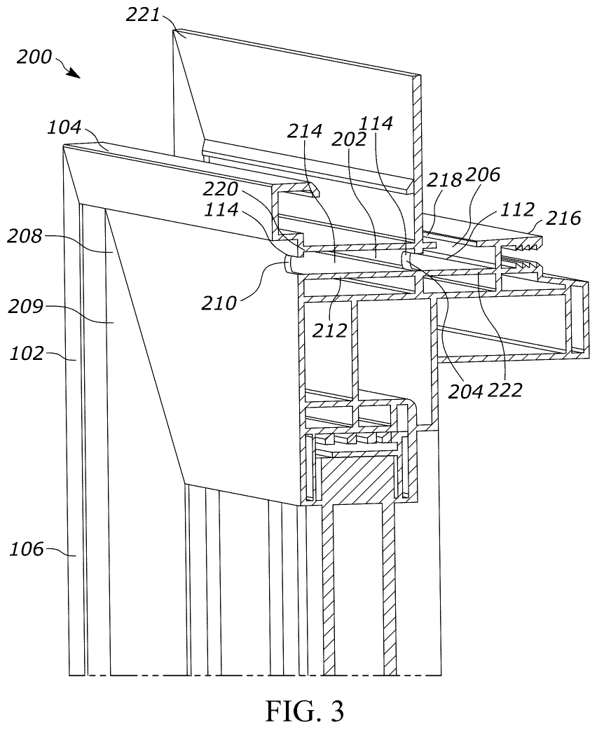

FIG. 3 is a detailed isometric cross-sectional view of the head 104 of the window 200 of FIG. 2. The head 104 includes a first head partition wall 202 that has a first weep hole 204 of the weep holes 114. The first head partition wall 202 defines a drainage channel 206. The drainage channel 112 is shown including drainage channel 206.

A head exterior wall 208 includes an exterior head face 209 and a second weep hole 210 of the weep holes 114. A second head partition wall 212 extends between the first head partition wall 202 and the head exterior wall 208. The second head partition wall 212 includes a fluid exit path 214 between the first weep hole 204 and the second weep hole 210. All or portions of the fluid exit path 214 may be sloped to facilitate drainage, for example.

The head 104 includes an interior head top wall 216 having an aperture 218, an exterior head top wall 220, and a head mounting flange 221 that separates the interior head top wall 216 and the exterior head top wall 220. The aperture 218 is fluidly coupled to the drainage channel 112. The aperture 218 is shown as a slot defined through the interior head top wall 216. The aperture 218 may be differently configured, however. The aperture 218 may be one or more through holes defined through the interior head top wall 216. The interior head top wall 216 is shown defining the drainage channel 112 along a width of the head 104. Fluid communication between the aperture 218 of the interior head top wall 216, the drainage channel 112, the first weep hole 204, and the second weep hole 210 enables fluid to flow from the interior head top wall 216, through the aperture 218, into the drainage channel 112, through the first weep hole 204, and out of the second weep hole 210 of the head exterior wall 208, in practice.

The head 104 has a third head partition wall 222 extending from the first head partition wall 202. The third head partition wall 222 defines the drainage channel 112 and is positioned beneath the interior head top wall 216 in the implementation shown.

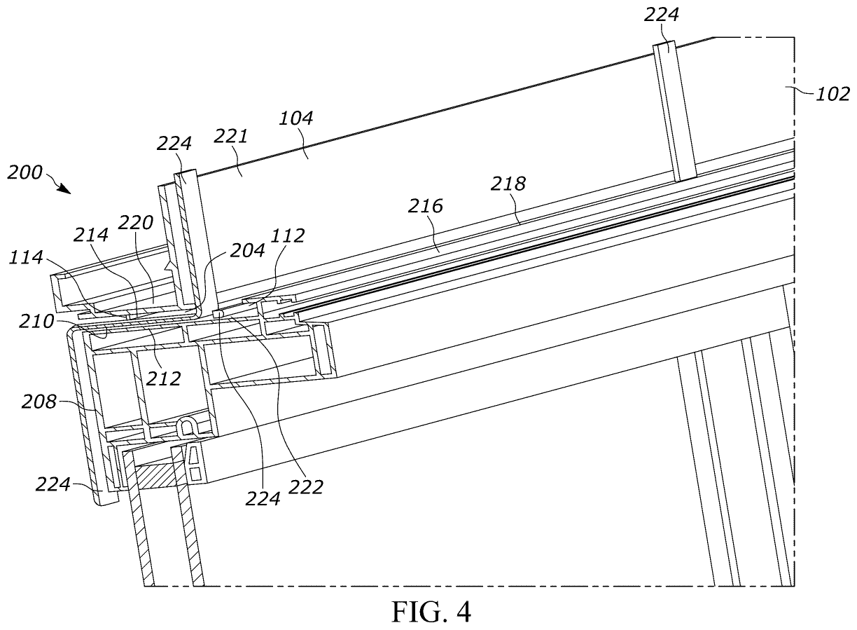

FIG. 4 is another detailed isometric cross-sectional view of the head 104 of the window 200 of FIG. 2. The head 104 of FIG. 4 shows the flow of fluid 224 through the perimeter drain channel 112 and out of head 104 through the fluid exit path 214.

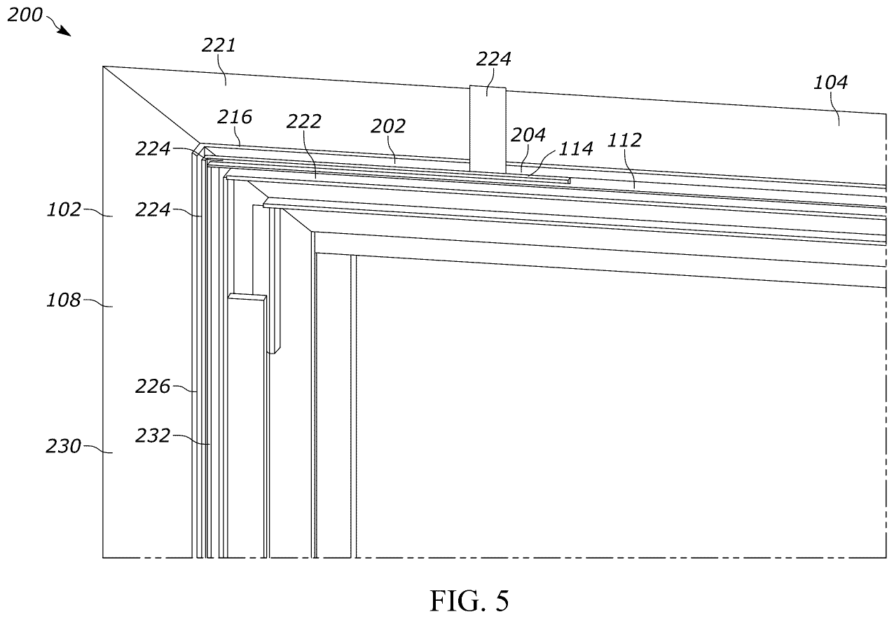

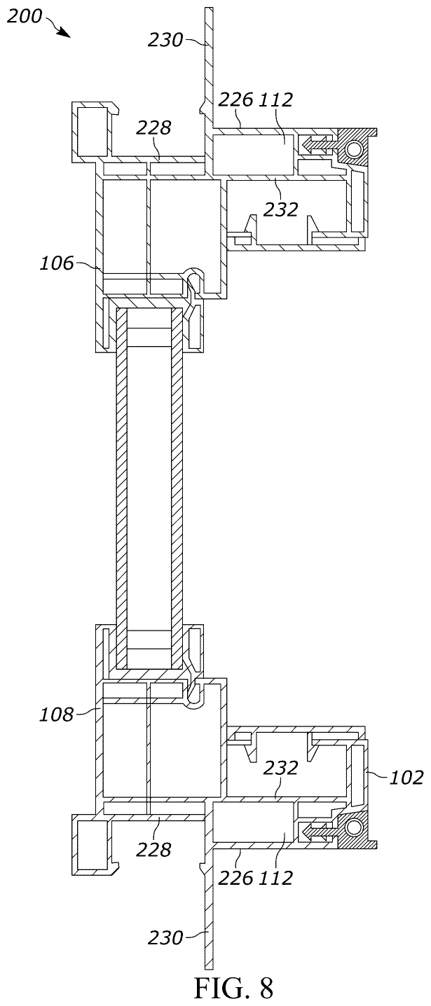

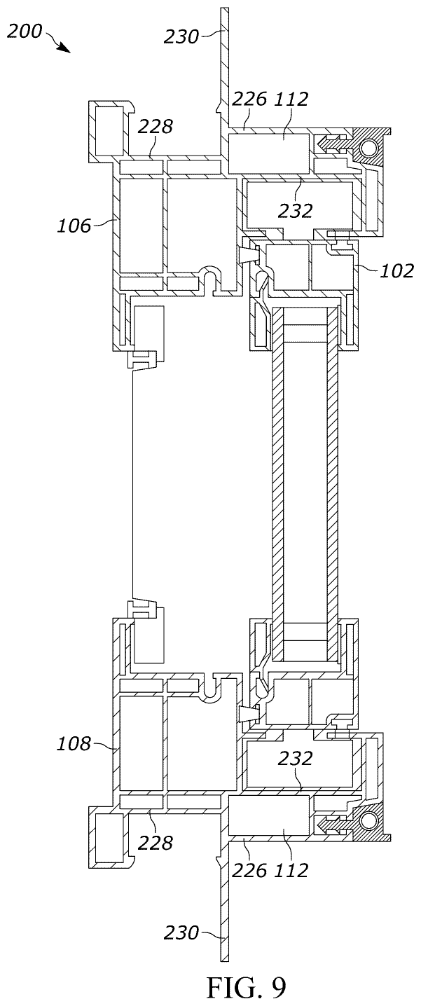

FIG. 5 is a detailed isometric partial cross-sectional view of the head 104 and the second jamb 108 of the window 200 of FIG. 2. While the second jamb 108 is described in association with FIG. 5, the first jamb 106 and the second jamb 108 have similar or the same structure. For example, the first jamb 106 may be a mirror image of the second jamb 108 as shown in FIGS. 8 and 9.

The second jamb 108 has an interior jamb side wall 226, an exterior jamb side wall 228 (see, FIGS. 8 and 9), a jamb mounting flange 230, and a jamb partition wall 232. The jamb mounting flange 230 separates the interior jamb side wall 226 and the exterior jamb side wall.

The exterior jamb side wall 228 and the jamb partition wall 232 define the drainage channel 112 in the implementation shown. The jamb partition wall 232 and the third head partition wall 222 are coupled and the interior jamb side wall 226 and the interior head top wall 216 are coupled.

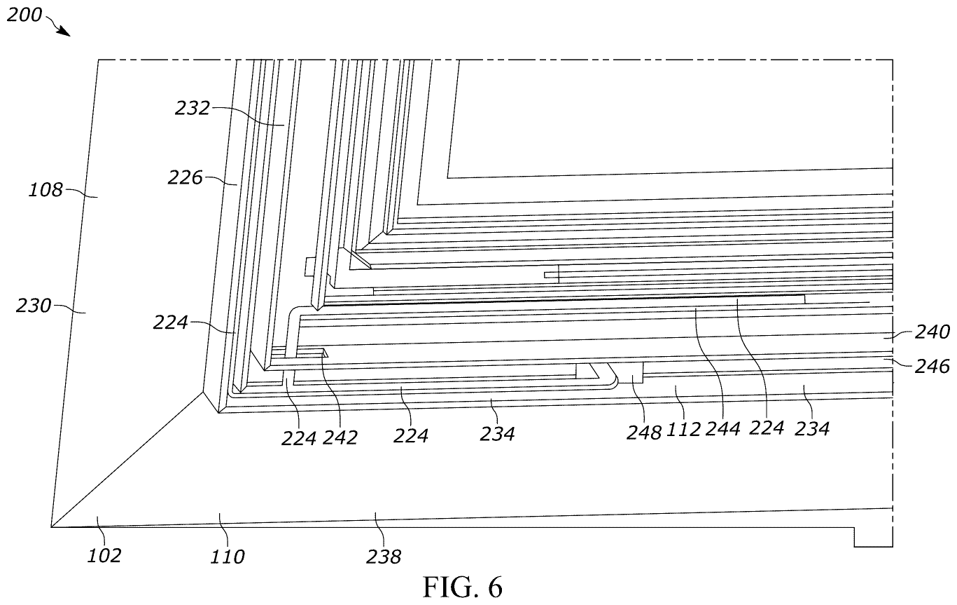

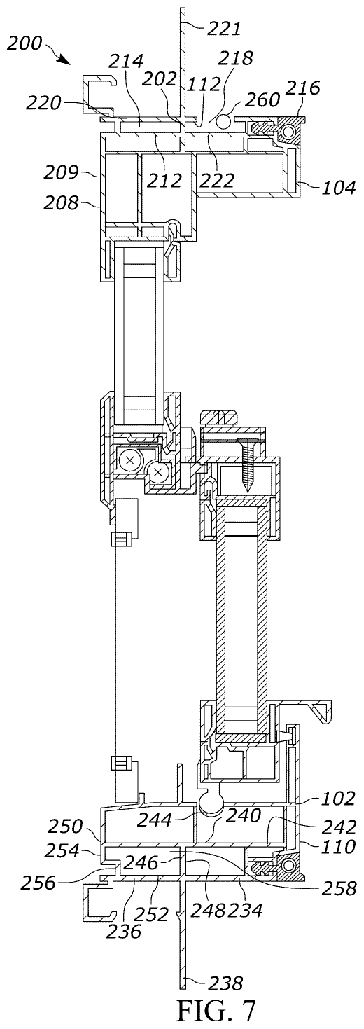

FIG. 6 is a detailed isometric partial cross-sectional view of the second jamb 108 and the sill 110 of the window 200 of FIG. 2. The sill 110 has an interior sill bottom wall 234, an exterior sill bottom wall 236 (see, FIG. 7), a sill mounting flange 238, and a first sill partition wall 240. The sill mounting flange 238 separates the interior sill bottom wall 234 and the exterior sill bottom wall 236 and the interior sill bottom wall 234 and the first sill partition wall 240 define the drainage channel 112 in the implementation shown. The first sill partition wall 240 includes a third weep hole 242 of the weep holes 114.

The sill 110 has a sill drainage channel 244 spaced above the drainage channel 112, in the implementation shown. All or portions of the sill drainage channel 244 may be sloped to facilitate drainage, for example. The third weep hole 242 fluidly couples the sill drainage channel 244 and the drainage channel 112, in the implementation shown. The sill 110 has a second sill partition wall 246 that extends between the interior sill bottom wall 234 and the first sill partition wall 240. The second sill partition wall 246 is shown defining the drainage channel 112 and including a fourth weep hole 248 of the weep holes 114. The jamb partition wall 232 and the first sill partition wall 240 are coupled and the interior jamb side wall 223 and the interior sill bottom wall 234 are coupled in the implementation shown.

FIG. 7 is a cross-sectional view of the window 200 of FIG. 2 taken along lines 7-7 of FIG. 2. The sill 110 includes a sill exterior wall 250 and a third sill partition wall 252. The sill exterior wall 250 includes an exterior sill face 254 and a fifth weep hole 256 of the weep holes 114. The third sill partition wall 252 extends between the second sill partition wall 246 and the sill exterior wall 250 and includes a second fluid exit path 258 between the fourth weep hole 248 and the fifth weep hole 256. All or portions of the second fluid exit path 258 may be sloped to facilitate drainage, for example. Fluid communication between the sill drainage channel 244, the third weep hole 242, the drainage channel 112, the fourth weep hole 248, and the fifth weep hole 256 enables fluid to flow from the sill drainage channel 244, through the third weep hole 242, into the drainage channel 112, through the fourth weep hole 248, and out of the fifth weep hole 256 of the sill exterior wall 250, in practice.

Wicking material 260 is shown included in the window 200 of FIG. 7. The wicking material 260 is shown being positioned in or adjacent the drainage channel 112. The wicking material 260 may additionally or alternatively be positioned in or adjacent the fluid exit path 214, the second fluid exit path 258, and/or any where on the window 200. The wicking material 260 may alternatively be omitted.

FIG. 8 is a cross-sectional view of the window 200 of FIG. 2 taken along lines 8-8 of FIG. 2.

FIG. 9 is a cross-sectional view of the window 200 of FIG. 2 taken along lines 9-9 of FIG. 2.

FIG. 10 is a schematic illustration of a fenestration unit 300 in accordance with the teachings of this disclosure. The fenestration unit 300 is similar to the fenestration unit 100 of FIG. 1. The first jamb 106 and the second jamb 108 of the fenestration unit 300 do not include the drainage channel 112, however. The first jamb 106 and/or the second jamb 108 may alternatively include a drainage channel that is not fluidly coupled to the drainage channel 112 of the head 104. The drainage channel of the first jamb 106 and/or the second jamb 108 may be fluidly coupled to the drainage channel 112 of the head sill 110 in some implementations.

The drainage channel 112 of the head 104 includes ends 302, 304. The ends 302, 304 may be implemented by a weld, caulk, or another structure to contain fluid within the drainage channel 112 and/or flowing past the ends 302, 304 of the drainage channel 112. The ends 302, 304 encourage fluid to flow from the drainage channel 112 of the head 104 and out of the weep holes 114 of the head 104. The weep holes 114 of the head 104 are fluidly coupled to the drainage channel 112 to evacuate fluid to an exterior at the head 104 in the implementation shown. The ends 302, 304 discourage the fluid from flowing from the drainage channel 112 and through and/or along the first jamb 106 and/or the second jamb 108. The fenestration unit 300 may be implemented as a door or a window.

The disclosed example inside/out water weeping system is developed to address a challenge in the window and door industry. As an example, the inside/out water weeping system is configured and/or engineered to manage water that bypasses a primary seal and enters the frame of a door or window. Rathan than allow this moisture to collect and cause structural damage as an example, the disclosed inside/out water weeping system directs the water through a built-in perimeter gutter and internal channel(s). The water is, thus, safely evacuated to the front exterior. The inside/out water weeping system may also control condensation that develops inside the structure by evacuating the water to the exterior. Interior walls, framing material, and/or finishes may be protected from damage that may otherwise occur from the condensation build up. The inside/out water weeping system channels water from the inside to the outside. Hidden water buildup is reduced and the useful product life may be increased as examples.

In many instances, window installation is performed improperly in one or more aspects, thereby creating points of leakage around the frame, at the sill, at corners and/or joints, at weep holes, at glass seals, and/or at flashing. For example, gaps between the window frame and the wall can allow water to seep in if not properly sealed with caulk or other sealing materials and the bottom part of the window adjacent the frame can be a leakage point if not properly flashed or sealed, allowing water to discharge on an interior side of the window at the sill. While conventional weep holes at the sill help drain water from the sill area, they cannot compensate for improper flashing or sealing and they can also be inadvertently blocked or improperly installed, fail to drain water, and allow water accumulation and/or discharge at an interior side of the window. Further, joints where the window components meet, especially at the corners, can be vulnerable to leaks if they are not sealed correctly and the seals between the glass panes and the window sash can deteriorate or be improperly installed, leading to leaks. Improper or missing flashing around the window may lead to water infiltration.

Conventional designs have long failed to recognize or address other points of leakage arising from improper installation and/or errors in manufacture and, accordingly, have long proved inadequate, particularly as to long-term reliability. Despite these long-standing deficiencies, the problem of, or potential for, leakage into and/or around the window at or around an interior upper portion of the window has remained unresolved.

In some aspects of the present concepts, a weeping window, door, or portal system is configured to weep, or direct fluid, from an interior portion of the window, door, or portal frame to an exterior portion of the window, door, or portal frame. For instance, for an example vinyl window frame, the interior portion of the frame of the vinyl window frame is the portion that lies behind the mounting flange and extends into the rough opening of the wall. While mentioned is made of vinyl windows, the present concepts apply equally to any frame material including, but not limited to, aluminum, fiberglass, or steel.

In some aspects of the present concepts, the frames described herein and/or the constituent subparts of the frames described herein (e.g., the head or horizontal part of the frame at the top, the jambs or vertical/lateral portions of the frame, or the sill or horizontal part of the frame at the bottom) and/or the constituent subparts of subparts of the frames and/or subparts of the window sashes are formed by extrusion. In some aspects of the present concepts, the frames described herein and/or the constituent subparts of the frames described herein (e.g., the head or horizontal part of the frame at the top, the jambs or vertical/lateral portions of the frame, or the sill or horizontal part of the frame at the bottom) and/or the constituent subparts of subparts of the frames and/or subparts of the window sashes are formed by additive manufacture (e.g., 3-D printing).

Contrary to conventional designs, in accord with at least some aspects of the present concepts, a window frame comprises a first flange disposed at an upper portion of the window frame, one or more first openings defined in one or more upper surfaces of the window frame on an interior side of the window frame behind the first flange, one or more second openings defined in one or more surfaces of the window frame on an exterior side of the window frame, and one or more fluid pathways defined in the frame to permit fluid transport from the one or more first openings to the one or more second openings.

Also contrary to conventional designs, in accord with at least some aspects of the present concepts, a window frame comprises a first lateral flange disposed at a first lateral side of the window frame, a second lateral flange disposed at a second lateral side of the window frame, one or more first openings defined in one or more lateral surfaces of the window frame on an interior side of the window frame behind the first lateral flange and/or one or more second openings defined in one or more lateral surfaces of the window frame on an interior side of the window frame behind the second lateral flange, one or more third openings defined in one or more surfaces of the window frame on an exterior side of the window frame at a middle portion (vertically) of the first lateral side and second lateral side of the window frame, and one or more fluid pathways defined in the frame to permit fluid transport from the one or more first openings and the one or more second openings to the one or more third openings.

In various examples of the present concepts, the window frame further comprises a single window pane, a single window pane borne within a sash, a plurality of window panes, or a plurality of window panes with each window pane borne within a respective sash. In some examples, one or more of the sashes bearing a window pane are movable (e.g., translatable and/or rotatable) relative to the window frame. The present concepts may be used in association with, for example, a single-hung, double-hung, spring-balanced, or casement window.

In some examples of the present concepts, further to the first flange, the window frame comprises a second flange disposed at a first lateral portion of the window frame, a third flange disposed at a second lateral portion of the window frame, and/or fourth flange disposed at a bottom portion of the window frame. In some examples, the first flange, second flange, third flange and/or fourth flange comprise an installation flange, a nailing fin, or an installation facilitator, such as is disclosed in U.S. Provisional Application No. 63/515,115, filed Jul. 23, 2023, titled “Windows and Doors Comprising Installation Plug or Plugs,” U.S. Provisional Application No. 63/603,624, filed Nov. 28, 2023, titled “Windows and Doors Comprising Installation Facilitator or Facilitators,” and U.S. Non-Provisional Patent Application Ser. No. 18/779,721, filed on Jul. 22, 2024, titled “Installation Facilitator for Framed Fixture”, each of which is incorporated by reference in its entirety herein.

In some examples of the present concepts, the one or more first openings of the window frame comprise a channel disposed laterally along at least a portion of the one or more upper surfaces of the window frame and/or comprise a plurality of slots and/or holes.

In various examples of the present concepts, the one or more second openings comprise one or more second openings defined at the upper portion of the window frame, one or more second openings defined at the upper portion of the window frame and one or more second openings defined at the middle portion of the window frame, or one or more second openings defined at each of the upper portion, the middle portion, and the lower portion of the window frame. Likewise, depending on the configuration, the window frame respectively comprises one or more fluid pathways defined in the upper portion of the window frame, the upper portion of the window frame and the middle portion of the window frame, or each of the upper portion, the middle portion, and the lower portion of the window frame.

In some examples of the present concepts, the one or more fluid pathways are at least substantially horizontal. As set forth herein, the phrase “substantially horizontal” takes into account manufacturing tolerances and includes horizontal itself.

In some examples of the present concepts, the one or more fluid pathways are sloped or angled downwardly along at least a portion of the one or more fluid pathways. For instance, a portion of a fluid pathway from an opening defined at the upper portion of the window frame inwardly disposed relative to a lateral portion of the window frame could be advantageously sloped along at least a portion of the length from the opening toward the lateral portion of the window frame. As another example, either in isolation or in combination with the preceding example, a portion of a fluid pathway from an opening defined at the upper portion of the window frame inwardly disposed relative to a lateral portion of the window frame could be advantageously sloped along at least a portion of the length from the opening toward a front or exterior portion of the window frame (e.g., at an upper portion of the window frame, a (lateral) middle portion of the window frame, etc.).

In various examples of the present concepts, the fluid pathways comprise one or more openings formed in internal walls of the window frame, one or more channels, or one or more closed conduits. In some examples, the one or more fluid pathways optionally comprise a wicking material along at least a portion of one or more of the one or more fluid pathways.

In some aspects of the present concepts, a door frame comprises a first flange disposed at an upper portion of the door frame, one or more first openings defined in one or more upper surfaces of the door frame on an interior side of the door frame behind the first flange, one or more second openings defined in one or more surfaces of the door frame on an exterior side of the door frame, and one or more fluid pathways defined in the frame to permit fluid transport from the one or more first openings to the one or more second openings.

In some aspects of the present concepts, a portal to receive a framed object comprises a first flange disposed at an upper portion of the portal to receive a framed object, one or more first openings defined in one or more upper surfaces of the portal to receive the framed object on an interior side of the portal to receive the framed object behind the first flange, one or more second openings defined in one or more surfaces of the portal to receive the framed object on an exterior side of the portal to receive the framed object, and one or more fluid pathways defined in the frame to permit fluid transport from the one or more first openings to the one or more second openings. By way of example, in a structure such as a high-rise, a fascia or exterior curtain of the structure may comprise a portal (e.g., a first frame) into which a window borne in a frame (e.g., a second frame) may be inserted and secured. In this example, an upper or middle portion of the framed window does not itself include the opening(s) and fluid pathway(s) described herein, but rather the portal comprises such features. Alternatively, of course, in a high-rise or other structure using other mounting structures, such as via slotted brackets hooked over “monkey bars,” or the like, the installed framed window could itself comprise the opening(s) and fluid pathway(s) described herein as set forth herein in preceding examples.

Examples of Combinations:

Example 1. An apparatus, comprising: a fenestration unit, comprising: a frame, comprising a head, a first jamb, a second jamb, and a sill, the first jamb and the second jamb coupled to and between the head and the sill, the head, the first jamb, the second jamb, and the sill comprise a perimeter drainage channel, and each of the head and the sill comprise weep holes fluidly coupled to the perimeter drainage channel.

Example 2. The apparatus of Example 1, wherein the head comprises: a first head partition wall comprises a first weep hole of the weep holes, the first head partition wall defines the perimeter drainage channel; a head exterior wall comprising an exterior head face and a second weep hole of the weep holes; and a second head partition wall extending between the first head partition wall and the head exterior wall, the second head partition wall comprises a fluid exit path between the first weep hole and the second weep hole.

Example 3. The apparatus of any one of the preceding Examples, wherein the head, comprises: an interior head top wall comprising an aperture, the aperture fluidly coupled to the perimeter drainage channel, the interior head top wall defines the perimeter drainage channel along a width of the head; an exterior head top wall; and a head mounting flange that separates the interior head top wall and the exterior head top wall.

Example 4. The apparatus of Example 3, wherein fluid communication between the aperture of the interior head top wall, the perimeter drainage channel, the first weep hole, and the second weep hole enables fluid to flow from the interior head top wall, through the aperture, into the perimeter drainage channel, through the first weep hole, and out of the second weep hole of the head exterior wall.

Example 5. The apparatus of any one of Examples 3-4, wherein the head comprises a third head partition wall extending from a first head partition wall, the third head partition wall defines the perimeter drainage channel and is positioned beneath the interior head top wall.

Example 6. The apparatus of any one of the preceding Examples, wherein each of the first jamb and the second jamb, comprise: an interior jamb side wall; an exterior jamb side wall; a jamb mounting flange that separates the interior jamb side wall and the exterior jamb side wall; and a jamb partition wall, wherein the exterior jamb side wall and the jamb partition wall define the perimeter drainage channel.

Example 7. The apparatus of Example 6, wherein the jamb partition wall and a third head partition wall are coupled.

Example 8. The apparatus of any one of Examples 6-7, wherein the interior jamb side wall and an interior head top wall are coupled.

Example 9. The apparatus of any one of the preceding Examples, wherein the sill, comprises: an interior sill bottom wall; an exterior sill bottom wall; a sill mounting flange that separates the interior sill bottom wall and the exterior sill bottom wall; and a first sill partition wall, wherein the interior sill bottom wall and the first sill partition wall define the perimeter drainage channel.

Example 10. The apparatus of Example 9, wherein the first sill partition wall comprises a third weep hole of the weep holes, wherein the sill comprises a sill drainage channel spaced above the perimeter drainage channel, the third weep hole fluidly coupling the sill drainage channel and the perimeter drainage channel.

Example 11. The apparatus of any one of Examples 9-10, wherein the sill comprises a second sill partition wall that extends between the interior sill bottom wall and the first sill partition wall, the second sill partition wall defines the perimeter drainage channel and comprises a fourth weep hole of the weep holes; and a sill exterior wall comprising an exterior sill face and a fifth weep hole of the weep holes; a third sill partition wall extending between the second sill partition wall and the sill exterior wall, the third sill partition wall comprises a second fluid exit path between the fourth weep hole and the fifth weep hole.

Example 12. The apparatus of Example 11, wherein fluid communication between the sill drainage channel, the third weep hole, the perimeter drainage channel, the fourth weep hole, and the fifth weep hole enables fluid to flow from the sill drainage channel, through the third weep hole, into the perimeter drainage channel, through the fourth weep hole, and out of the fifth weep hole of the sill exterior wall.

Example 13. The apparatus of any one of Examples 9-12, wherein a jamb partition wall and the first sill partition wall are coupled.

Example 14. The apparatus of any one of Examples 9-12, wherein an interior jamb side wall and the interior sill bottom wall are coupled.

Example 15. The apparatus of any one of the preceding Examples, further comprising wicking material.

Example 16. The apparatus of Example 15, wherein the wicking material is positioned in or adjacent the perimeter drainage channel, a fluid exit path, or a second fluid exit path.

Example 17. The apparatus of any one of the preceding Examples, wherein the fenestration unit comprises a window.

Example 18. The apparatus of any one of the preceding Examples, wherein the fenestration unit comprises a door.

Example 19. An apparatus, comprising: a frame, comprising a head, a first jamb, a second jamb, and a sill, the first jamb and the second jamb coupled to and between the head and the sill, the head comprising: a first head partition wall comprises a first weep hole of the weep holes, the first head partition wall defines a drainage channel; a head exterior wall comprising an exterior head face and a second weep hole of the weep holes; and a second head partition wall extending between the first head partition wall and the head exterior wall, the second head partition wall comprises a fluid exit path between the first weep hole and the second weep hole, wherein fluid communication between the drainage channel, the first weep hole, and the second weep hole enables fluid to flow from the drainage channel, through the first weep hole, and out of the second weep hole of the head exterior wall.

Example 20. The apparatus of Example 19, wherein the head, comprises: an interior head top wall comprising an aperture, the interior head top wall defines the drainage channel along a width of the head, the aperture fluidly coupled to the drainage channel; an exterior head top wall; and a head mounting flange that separates the interior head top wall and the exterior head top wall.

Example 21. The apparatus of Example 20, wherein the head comprises a third head partition wall extending from the first head partition wall, the third head partition wall defines the drainage channel and is positioned beneath the interior head top wall.

Example 22. The apparatus of Example 21, wherein the frame comprises a perimeter drainage channel comprising the drainage channel, wherein the sill, comprises: an interior sill bottom wall; a first sill partition wall comprising a third weep hole, wherein the interior sill bottom wall and the first sill partition wall define the perimeter drainage channel; and a sill drainage channel spaced above the perimeter drainage channel, the third weep hole fluidly coupling the sill drainage channel and the perimeter drainage channel.

Example 23. An apparatus, comprising: a frame, comprising a head, a first jamb, a second jamb, and a sill, the first jamb and the second jamb coupled to and between the head and the sill, the head comprising: an interior head top wall comprising an aperture, the interior head top wall defines a drainage channel along the head, the aperture fluidly coupled to the drainage channel; a first head partition wall comprises a first weep hole of the weep holes, the first head partition wall defines the drainage channel; a head exterior wall comprising an exterior head face and a second weep hole of the weep holes; and a second head partition wall extending between the first head partition wall and the head exterior wall, the second head partition wall comprises a fluid exit path between the first weep hole and the second weep hole, an exterior head top wall; and a head mounting flange that separates the interior head top wall and the exterior head top wall, wherein fluid communication between aperture of the head top wall, the drainage channel, the first weep hole, and the second weep hole enables fluid to flow through the aperture, into the drainage channel, through the first weep hole, and out of the second weep hole of the head exterior wall.

Example 24. The apparatus of Example 23, wherein the head comprises a third head partition wall extending from the first head partition wall, the third head partition wall defines the drainage channel and is positioned beneath the interior head top wall.

Example 25. An apparatus, comprising: a fenestration unit, comprising: a frame, comprising a head, a first jamb, a second jamb, and a sill, the first jamb and the second jamb coupled to and between the head and the sill, the head, comprises: a drainage channel, and weep holes fluidly coupled to the drainage channel to evacuate fluid to an exterior at the head.

Example 26. The apparatus of Example 25, wherein the head comprises: a first head partition wall comprises a first weep hole of the weep holes, the first head partition wall defines the drainage channel; a head exterior wall comprising an exterior head face and a second weep hole of the weep holes; and a second head partition wall extending between the first head partition wall and the head exterior wall, the second head partition wall comprises a fluid exit path between the first weep hole and the second weep hole.

Example 27. The apparatus of any one of Examples 25-26, wherein the head, comprises: an interior head top wall comprising an aperture, the aperture fluidly coupled to the drainage channel, the interior head top wall defines the drainage channel; an exterior head top wall; and a head mounting flange that separates the interior head top wall and the exterior head top wall.

Example 28. The apparatus of Example 27, wherein fluid communication between the aperture of the interior head top wall, the drainage channel, the first weep hole, and the second weep hole enables fluid to flow from the interior head top wall, through the aperture, into the drainage channel, through the first weep hole, and out of the second weep hole of the head exterior wall.

Example 29. The apparatus of any one of Examples 26-28, wherein the head comprises a third head partition wall extending from the first head partition wall, the third head partition wall defines the drainage channel and is positioned beneath an interior head top wall.

Example 30. The apparatus of any one of Examples 25-29, wherein the drainage channel comprises ends.

Example 31. The apparatus of Example 30, wherein the ends encourage the fluid to flow from the drainage channel and out of the weep holes of the head.

Example 32. The apparatus of any one of Examples 30-31, wherein the ends discourage the fluid from flowing from the drainage channel and through or along the first jamb or the second jamb.

Example 33. The apparatus of any one of Example 25-32, wherein the fenestration unit comprises a door.

Example 34. The apparatus of any one of Examples 25-32, wherein the fenestration unit comprises a window.

Example 35. A window frame, comprising: a first flange disposed at an upper portion of the window frame; one or more first openings defined in one or more upper surfaces of the window frame on an interior side of the window frame behind the first flange; one or more second openings defined in one or more surfaces of the window frame on an exterior side of the window frame; and one or more fluid pathways defined in the frame to permit fluid transport from the one or more first openings to the one or more second openings.

Example 36. The window frame according to Example 35, further comprising a single window pane fixed in the window frame.

Example 37. The window frame according to Example 35, further comprising a plurality of window panes.

Example 38. The window frame according to Example 35, further comprising a plurality of window panes, at least one window pane being movable relative to the window frame.

Example 39. The window frame according to any of Examples 35-38, further comprising a second flange disposed at a first lateral portion of the window frame.

Example 40. The window frame according to any of Examples 35-39, further comprising a third flange disposed at a second lateral portion of the window frame.

Example 41. The window frame according to any of Examples 35-40, further comprising a fourth flange disposed at a bottom portion of the window frame.

Example 42. The window frame according to any of Examples 35-41, wherein the first flange, second flange, third flange and/or fourth flange comprise an installation flange, a nailing fin, or an installation facilitator.

Example 43. The window frame according to any of Examples 35-42, wherein the one or more first openings comprise a channel disposed laterally along at least a portion of the one or more upper surfaces of the window frame.

Example 44. The window frame according to any of Examples 35-43, wherein the one or more second openings are defined at the upper portion of the window frame.

Example 45. The window frame according to any of Examples 35-44, wherein the one or more second openings are defined at a middle portion of the window frame.

Example 46. The window frame according to any of Examples 35-45, wherein the one or more second openings are defined at a lower portion of the window frame.

Example 47. The window frame according to any of Examples 35-46, wherein the one or more fluid pathways are defined in the upper portion of the window frame.

Example 48. The window frame according to Example 47, wherein the one or more fluid pathways are further defined in the middle portion of the window frame.

Example 49. The window frame according to Example 48, wherein the one or more fluid pathways are further defined in the lower portion of the window frame.

Example 50. The window frame according to Example 44, wherein the one or more fluid pathways are defined in the upper portion of the window frame and wherein the one or more fluid pathways are at least substantially horizontal.

Example 51. The window frame according to Example 44, wherein the one or more fluid pathways are defined in the upper portion of the window frame and wherein at least one of the one or more fluid pathways are angled downwardly along at least a portion of the one or more fluid pathway.

Example 52. The window frame according to Example 44, wherein the one or more fluid pathways comprise one or more openings formed in internal walls of the window frame, one or more channels, or one or more closed conduits.

Example 53. The window frame according to Example 53, wherein the one or more fluid pathways optionally comprise a wicking material along at least a portion of the one or more fluid pathways.

Example 54. A door frame, comprising: a first flange disposed at an upper portion of the door frame; one or more first openings defined in one or more upper surfaces of the door frame on an interior side of the door frame behind the first flange; one or more second openings defined in one or more surfaces of the door frame on an exterior side of the door frame; and one or more fluid pathways defined in the frame to permit fluid transport from the one or more first openings to the one or more second openings.

Example 55. The door frame according to Example 54, further comprising a second flange disposed at a first lateral portion of the door frame.

Example 56. The door frame according to Example 54 or Example 55, further comprising a third flange disposed at a second lateral portion of the door frame.

Example 57. The door frame according to any of Examples 55-56, wherein the first flange, second flange and/or third flange comprise an installation flange, a nailing fin, or an installation facilitator.

Example 58. The door frame according to any of Examples 55-57, wherein the one or more first openings comprise a channel disposed laterally along at least a portion of the one or more upper surfaces of the door frame.

Example 59. The door frame according to any of Examples 55-58, wherein the one or more second openings are defined at the upper portion of the door frame.

Example 60. The door frame according to any of Examples 55-59, wherein the one or more second openings are defined at a middle portion of the door frame.

Example 61. The door frame according to any of Examples 55-60, wherein the one or more second openings are defined at a lower portion of the door frame.

Example 62. The door frame according to any of Examples 55-61, wherein the one or more fluid pathways are defined in the upper portion of the door frame.

Example 63. The door frame according to Example 62, wherein the one or more fluid pathways are further defined in the middle portion of the door frame.

Example 64. The door frame according to Example 63, wherein the one or more fluid pathways are further defined in the lower portion of the door frame.

Example 65. The door frame according to Example 59, wherein the one or more fluid pathways are defined in the upper portion of the door frame and wherein the one or more fluid pathways are at least substantially horizontal.

Example 66. The door frame according to Example 59, wherein the one or more fluid pathways are defined in the upper portion of the door frame and wherein the one or more fluid pathways form a fluid pathway that is angled downwardly along at least a portion of the one or more channels.

Example 67. The door frame according to Example 59, wherein the one or more fluid pathways comprise one or more openings formed in internal walls of the door frame, one or more channels, or one or more closed conduits.

Example 68. The door frame according to Example 67, wherein the one or more fluid pathways optionally comprise a wicking material along at least a portion of the one or more fluid pathways.

Example 69. A portal to receive a framed object, comprising: a first flange disposed at an upper portion of the portal to receive a framed object; one or more first openings defined in one or more upper surfaces of the portal to receive the framed object on an interior side of the portal to receive the framed object behind the first flange; one or more second openings defined in one or more surfaces of the portal to receive the framed object on an exterior side of the portal to receive the framed object; and one or more fluid pathways defined in the frame to permit fluid transport from the one or more first openings to the one or more second openings.

Example 70. The portal to receive the framed object according to Example 69, wherein the framed object comprises a framed window.

Example 71. The portal to receive the framed object according to Example 69, wherein the framed object comprises a door.

Example 72. The portal to receive the framed object according to Example 69, wherein the framed object comprises framing for a passageway.

Example 73. The portal to receive the framed object according to any of Examples 69-72, further comprising a second flange disposed at a first lateral portion of the portal to receive the framed object.

Example 74. The portal to receive the framed object according to any of Examples 69-73, further comprising a third flange disposed at a second lateral portion of the portal to receive the framed object.

Example 75. The portal to receive the framed object according to any of Examples 69-74, further comprising a fourth flange disposed at a bottom portion of the portal to receive the framed object.

Example 76. The portal to receive the framed object according to any of Examples 69-75, wherein the first flange, second flange, third flange and/or fourth flange comprise an installation flange, a nailing fin, or an installation facilitator.

Example 77. The portal to receive the framed object according to any of Examples 69-76, wherein the one or more first openings comprise a channel disposed laterally along at least a portion of the one or more upper surfaces of the portal to receive the framed object.

Example 78. The portal to receive the framed object according to any of Examples 69-77, wherein the one or more second openings are defined at the upper portion of the portal to receive the framed object.

Example 79. The portal to receive the framed object according to any of Examples 69-78, wherein the one or more second openings are defined at a middle portion of the portal to receive the framed object.

Example 80. The portal to receive the framed object according to any of Examples 69-79, wherein the one or more second openings are defined at a lower portion of the portal to receive the framed object.

Example 81. The portal to receive the framed object according to any of Examples 69-80, wherein the one or more fluid pathways are defined in the upper portion of the portal to receive the framed object.

Example 82. The portal to receive the framed object according to Example 81, wherein the one or more fluid pathways are further defined in the middle portion of the portal to receive the framed object.

Example 83. The portal to receive the framed object according to Example 82, wherein the one or more fluid pathways are further defined in the lower portion of the portal to receive the framed object.

Example 84. The portal to receive the framed object according to Example 80, wherein the one or more fluid pathways are defined in the upper portion of the portal to receive the framed object and wherein the one or more fluid pathways are at least substantially horizontal.

Example 85. The portal to receive the framed object according to Example 80, wherein the one or more fluid pathways are defined in the upper portion of the portal to receive the framed object and wherein the one or more fluid pathways form a fluid pathway that is angled downwardly along at least a portion of the one or more channels.

Example 86. The portal to receive the framed object according to Example 80, wherein the one or more fluid pathways comprise one or more openings formed in internal walls of the portal to receive the framed object, one or more channels, or one or more closed conduits.

Example 87. The portal to receive the framed object according to Example 86, wherein the one or more fluid pathways optionally comprise a wicking material along at least a portion of the one or more fluid pathways.

The following claims recite aspects of certain examples of the disclosed subject matter and are considered to be part of the above disclosure. These aspects may be combined with one another.

1. An apparatus, comprising:
a fenestration unit, comprising:
a frame, comprising a head, a first jamb, a second jamb, and a sill, the first jamb and the second jamb coupled to and between the head and the sill,
the head, the first jamb, the second jamb, and the sill comprise a perimeter drainage channel, and
each of the head and the sill comprise weep holes fluidly coupled to the perimeter drainage channel.

2. The apparatus of claim 1, wherein the head comprises:
a first head partition wall comprises a first weep hole of the weep holes, the first head partition wall defines the perimeter drainage channel;
a head exterior wall comprising an exterior head face and a second weep hole of the weep holes; and
a second head partition wall extending between the first head partition wall and the head exterior wall, the second head partition wall comprises a fluid exit path between the first weep hole and the second weep hole.

3. The apparatus of claim 1, wherein the head, comprises:
an interior head top wall comprising an aperture, the aperture fluidly coupled to the perimeter drainage channel, the interior head top wall defines the perimeter drainage channel along a width of the head;
an exterior head top wall; and
a head mounting flange that separates the interior head top wall and the exterior head top wall.

4. The apparatus of claim 3, wherein fluid communication between the aperture of the interior head top wall, the perimeter drainage channel, the first weep hole, and the second weep hole enables fluid to flow from the interior head top wall, through the aperture, into the perimeter drainage channel, through the first weep hole, and out of the second weep hole of the head exterior wall.

5. The apparatus of claim 3, wherein the head comprises a third head partition wall extending from a first head partition wall, the third head partition wall defines the perimeter drainage channel and is positioned beneath the interior head top wall.

6. (canceled)

7. (canceled)

8. (canceled)

9. The apparatus of claim 1, wherein the sill, comprises:
an interior sill bottom wall;
an exterior sill bottom wall;
a sill mounting flange that separates the interior sill bottom wall and the exterior sill bottom wall; and
a first sill partition wall, wherein the interior sill bottom wall and the first sill partition wall define the perimeter drainage channel.

10. The apparatus of claim 9, wherein the first sill partition wall comprises a third weep hole of the weep holes, wherein the sill comprises a sill drainage channel spaced above the perimeter drainage channel, the third weep hole fluidly coupling the sill drainage channel and the perimeter drainage channel.

11. The apparatus of claim 9, wherein the sill comprises a second sill partition wall that extends between the interior sill bottom wall and the first sill partition wall, the second sill partition wall defines the perimeter drainage channel and comprises a fourth weep hole of the weep holes; and
a sill exterior wall comprising an exterior sill face and a fifth weep hole of the weep holes; and
a third sill partition wall extending between the second sill partition wall and the sill exterior wall, the third sill partition wall comprises a second fluid exit path between the fourth weep hole and the fifth weep hole.

12.-18. (canceled)

19. An apparatus, comprising:
a frame, comprising a head, a first jamb, a second jamb, and a sill, the first jamb and the second jamb coupled to and between the head and the sill, the head comprising:
a first head partition wall comprises a first weep hole of the weep holes, the first head partition wall defines a drainage channel;
a head exterior wall comprising an exterior head face and a second weep hole of the weep holes; and
a second head partition wall extending between the first head partition wall and the head exterior wall, the second head partition wall comprises a fluid exit path between the first weep hole and the second weep hole,
wherein fluid communication between the drainage channel, the first weep hole, and the second weep hole enables fluid to flow from the drainage channel, through the first weep hole, and out of the second weep hole of the head exterior wall.

20. The apparatus of claim 19, wherein the head, comprises:
an interior head top wall comprising an aperture, the interior head top wall defines the drainage channel along a width of the head, the aperture fluidly coupled to the drainage channel;
an exterior head top wall; and
a head mounting flange that separates the interior head top wall and the exterior head top wall.

21. The apparatus of claim 20, wherein the head comprises a third head partition wall extending from the first head partition wall, the third head partition wall defines the drainage channel and is positioned beneath the interior head top wall.

22. The apparatus of claim 21, wherein the frame comprises a perimeter drainage channel comprising the drainage channel, wherein the sill, comprises:
an interior sill bottom wall;
a first sill partition wall comprising a third weep hole, wherein the interior sill bottom wall and the first sill partition wall define the perimeter drainage channel; and
a sill drainage channel spaced above the perimeter drainage channel, the third weep hole fluidly coupling the sill drainage channel and the perimeter drainage channel.

23. An apparatus, comprising:
a frame, comprising a head, a first jamb, a second jamb, and a sill, the first jamb and the second jamb coupled to and between the head and the sill, the head comprising:
an interior head top wall comprising an aperture, the interior head top wall defines a drainage channel along the head, the aperture fluidly coupled to the drainage channel;
a first head partition wall comprises a first weep hole of the weep holes, the first head partition wall defines the drainage channel;
a head exterior wall comprising an exterior head face and a second weep hole of the weep holes; and
a second head partition wall extending between the first head partition wall and the head exterior wall, the second head partition wall comprises a fluid exit path between the first weep hole and the second weep hole,
an exterior head top wall; and
a head mounting flange that separates the interior head top wall and the exterior head top wall,
wherein fluid communication between aperture of the head top wall, the drainage channel, the first weep hole, and the second weep hole enables fluid to flow through the aperture, into the drainage channel, through the first weep hole, and out of the second weep hole of the head exterior wall.

24. The apparatus of claim 23, wherein the head comprises a third head partition wall extending from the first head partition wall, the third head partition wall defines the drainage channel and is positioned beneath the interior head top wall.

25. An apparatus, comprising:
a fenestration unit, comprising:
a frame, comprising a head, a first jamb, a second jamb, and a sill, the first jamb and the second jamb coupled to and between the head and the sill,
the head, comprises:
a drainage channel, and
weep holes fluidly coupled to the drainage channel to evacuate fluid to an exterior at the head.

26. The apparatus of claim 25, wherein the head comprises:
a first head partition wall comprises a first weep hole of the weep holes, the first head partition wall defines the drainage channel;
a head exterior wall comprising an exterior head face and a second weep hole of the weep holes; and
a second head partition wall extending between the first head partition wall and the head exterior wall, the second head partition wall comprises a fluid exit path between the first weep hole and the second weep hole.

27. The apparatus 25, wherein the head, comprises:
an interior head top wall comprising an aperture, the aperture fluidly coupled to the drainage channel, the interior head top wall defines the drainage channel;
an exterior head top wall; and
a head mounting flange that separates the interior head top wall and the exterior head top wall.

28. The apparatus of claim 27, wherein fluid communication between the aperture of the interior head top wall, the drainage channel, the first weep hole, and the second weep hole enables fluid to flow from the interior head top wall, through the aperture, into the drainage channel, through the first weep hole, and out of the second weep hole of the head exterior wall.

29. The apparatus of claim 26, wherein the head comprises a third head partition wall extending from the first head partition wall, the third head partition wall defines the drainage channel and is positioned beneath an interior head top wall.

30. The apparatus of claim 25, wherein the drainage channel comprises ends.

31. The apparatus of claim 30, wherein the ends encourage the fluid to flow from the drainage channel and out of the weep holes of the head.

32. The apparatus of claim 30, wherein the ends discourage the fluid from flowing from the drainage channel and through or along the first jamb or the second jamb.

33. The apparatus of claim 25, wherein the fenestration unit comprises a door.

34. The apparatus of claim 25, wherein the fenestration unit comprises a window.
